(19) United States
(12) Patent Application Publication
(10) Pub. No.: US 2014/0068547 A1
(43) Pub. Date: Mar. 6, 2014

(54) SHARING APPLICATION CODE ACROSS PLATFORMS

(71) Applicants: Vinay Kumar, Hyderabad (IN); Rakesh Midha, Hyderabad (IN); Deepak Kumar Pratinidhi, Hyderabad (IN); Benoit Barabe, Redmond, WA (US); Donovan Lange, Redmond, WA (US); Kentaro Urata, Redmond, WA (US); Daniel Escapa, Redmond, WA (US)

(72) Inventors: Vinay Kumar, Hyderabad (IN); Rakesh Midha, Hyderabad (IN); Deepak Kumar Pratinidhi, Hyderabad (IN); Benoit Barabe, Redmond, WA (US); Donovan Lange, Redmond, WA (US); Kentaro Urata, Redmond, WA (US); Daniel Escapa, Redmond, WA (US)

(73) Assignee: MICROSOFT CORPORATION, Redmond, WA (US)

(21) Appl. No.: 13/604,342

(22) Filed: Sep. 5, 2012

(51) Int. Cl. G06F 9/44

(52) U.S. Cl. 717/104

(57) ABSTRACT

Application functionality is separated into platform neutral components and platform specific components. An application model component defines the core logic of the application and includes interaction models for handling user input that is platform neutral and may be used across platforms. An application host component includes functionality for a specific platform but may be reused across different applications on the same platform (e.g. how to draw on a specific platform). An application user interface component includes functionality (e.g. specific UI for an application) that is platform specific and application specific. Platform neutral Application Programming Interfaces (APIs) are used by the developer to abstract functionality of the application such that the platform neutral code is portable across different platforms. The communication between the platform specific components and platform neutral components uses thread and memory isolation similar to a client-server architecture.

### BACKGROUND

An application is typically designed and created for one platform which is then ported to additional platforms. For example, an application may be initially created for a mobile device using a first operating system and then ported to a similar type of mobile device using a different operating system. Each type of platform has platform specific system calls and functionality as well disparity in the way it handles text/touch input. Most times, when application is ported there are significant changes to the code requiring very high effort.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Application functionality is separated into platform neutral components and platform specific components. The components include platform neutral functionality for what to draw and how to interact with input as well as platform specific functionality that defines how to draw and interact with content on a specific platform. An application model component defines the platform neutral core logic of the application and includes interaction models for handling user input as well as drawing to an abstract canvas that is and may be used across platforms. An application host component includes functionality for a specific platform but may be reused across different applications on the same platform (e.g. how to draw on a specific platform). An application user interface component includes functionality (e.g. specific UI for an application) that is platform specific and application specific. Platform neutral Application Programming Interfaces (APIs) are used by the developer to abstract functionality of the application such that the platform neutral code is portable across different platforms. For example, the APIs may include interfaces for rendering, text input, touch input, selection of content, copying/pasting, system events, and the like. The communication between the platform specific components and platform neutral components uses thread and memory isolation similar to a client-server architecture. For example, communication between the platform specific components and the platform neutral components uses asynchronous calls and a message queue.

### BRIEF DESCRIPTION OF THE DRAWINGS

FIG. 1 illustrates an exemplary sharing of code between two different mobile device platforms;

FIG. 2 shows an architecture for sharing code across different platforms;

FIG. 3 shows exemplary interfaces for sharing code across platforms;

FIG. 4 shows exemplary interfaces for to an application canvas;

FIG. 5 shows exemplary touch interfaces;

FIG. 6 shows exemplary text interfaces;

FIG. 7 shows exemplary carat and copy/paste interfaces;

FIG. 8 shows asynchronous communication and threading between an application model and different platforms;

FIG. 9 shows an illustrative process for sharing code across different platforms; and

FIGS. 10-13 and the associated descriptions provide a discussion of a variety of operating environments in which embodiments of the invention may be practiced.

### DETAILED DESCRIPTION

Referring now to the drawings, in which like numerals represent like elements, various embodiments will be described.

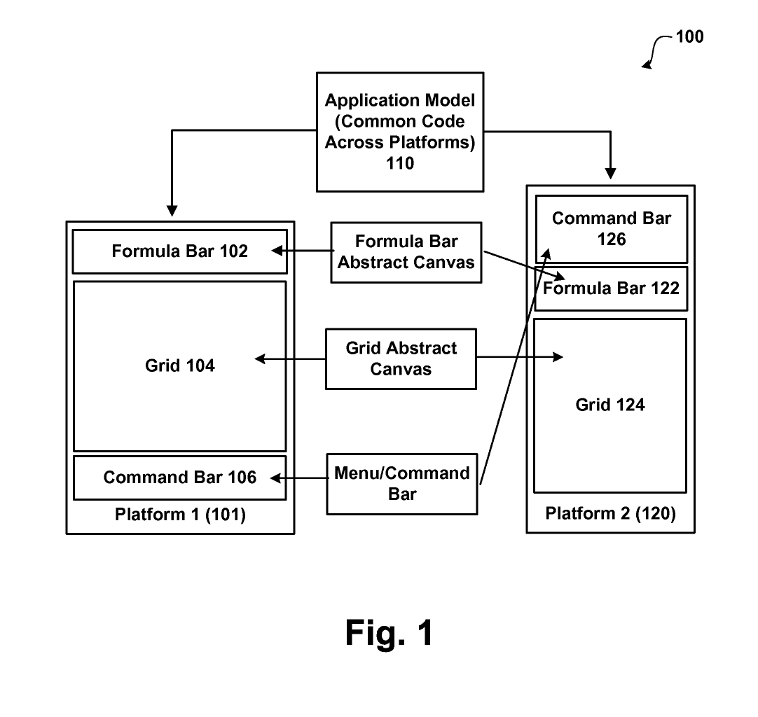

FIG. 1 illustrates an exemplary sharing of code between two different mobile device platforms. As illustrated, system 100 includes platform 1 (101) and platform 2 (120) that share application model 110.

As discussed herein, an application module, such as application model 110, defines the platform neutral core logic of an application and includes interaction models for handling user input as well as drawing to an abstract canvas that is used across different platforms. In other words, the same code defined by the application model 110 is used by a first platform (e.g. an APPLE device) that is also used by a different platform (e.g. a MICROSOFT device, ANDROID device, . . . ). Instead of creating separate code for each type of platform (e.g. MICROSOFT WINDOWS PHONE 8, IPHONE, GOOGLE ANDROID . . . ), all of the code in the application model is shared across platforms.

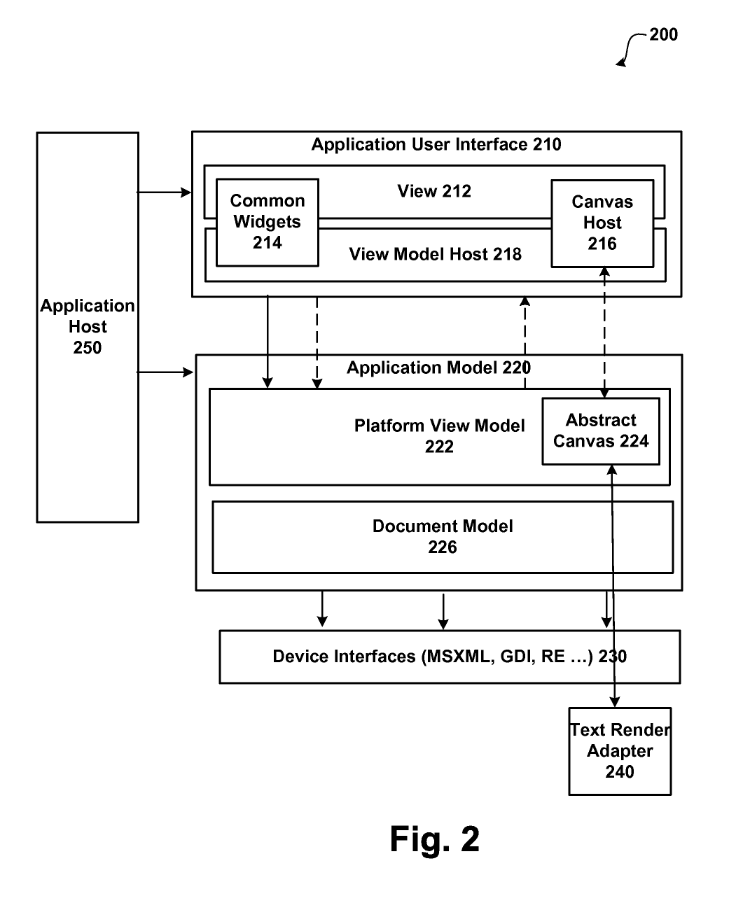

A developer develops an application that includes code that uses platform neutral APIs for creating the common code that is consistent for the application. For example, APIs are used by the developer to draw/write to an abstract canvas that is platform neutral. In many types of applications (e.g. mobile device applications), writing to the platform's canvas is a large portion of the code. Generally, what to draw and the desired input handling behavior accounts for a vast majority of the code for an application (e.g. 5000K for the platform neutral code as compared to 50K for platform specific code) and is included in an application model (See FIG. 2). The menu/command bar view module may also be developed to be platform independent. For each type of platform, device specific code is developed to change the platform neutral API calls to device specific code.

As shown in FIG. 1 even though the same common code is used to define what to draw to a screen of a platform, the layouts may be customized for each device such that is look and feel is maintained.

For example, platform 101 includes a formula bar 102, grid 104 and command bar 106 in a first position and platform 120 includes a formula bar 122, grid 124 and command bar 126 in a different position. Platform specific code may be developed to render content according to each type of platform. While each platform includes specific interfaces for rendering and input that use device specific code, the majority of the code for the application is common code that is shared between platforms.

FIG. 2 shows an architecture 200 for sharing code across different platforms. As illustrated, FIG. 2 comprises an application user interface (UI) 210, an application model 220, device interfaces 230, text render adapter 240 and application host 250. Asynchronous calls are represented by dashed lines and synchronous calls are represented by solid lines.

Application UI 210 includes view 212, view model host 218, common widgets 214 and canvas host 216. Application model 220 includes platform view model 222, abstract canvas 224 and document model 226.

Platform specific code that is application neutral includes code for the application host 250 (e.g. application management and services), common widgets 214, canvas host 216, and device interfaces 240. Application host 250 includes platform specific application neutral code for providing application management and services.

Platform neutral code that is application specific includes the code for the application model 220. Application model component 220 defines the core logic of the application and include what to draw and interaction models for handling user input that is platform neutral and may be used across platforms. The code for the application model component includes the use of platform neutral APIs (described below) for drawing to and interacting with abstract canvas 224. According to an embodiment, the code and the code executed within the application model component 220 is the same code that is used across different platforms. In other words, conditional expressions are not used to delineate execution of code for one platform or another (e.g. if Platform 1 then execute this block, or if Platform 2 then execute this other block). Document model 226 is a platform neutral model for interacting with objects.

Platform specific and application specific code includes the code for view 212, view model host 218 and text render adapter 240.

Application user interface component 210 is platform specific and is coded for each specific platform.

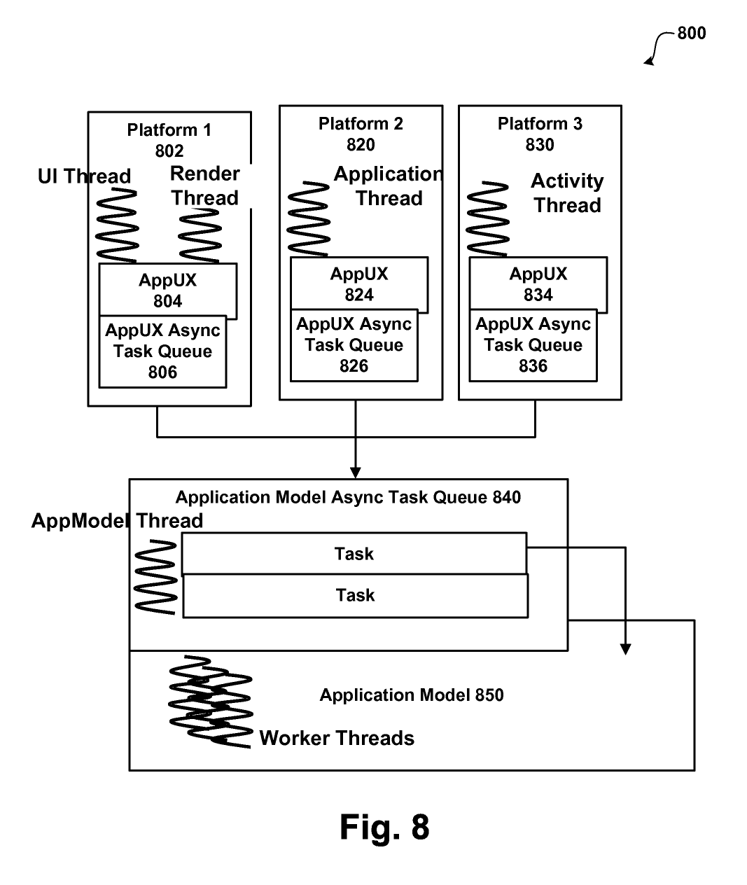

The application user interface component 210 may communicate using asynchronous and/or synchronous calls. Interfaces are defined (see below) that clearly show what calls may be made asynchronously or synchronously. Application user interface component 210 delivers user input/data to application model 220. Receives application events from the application model 220 and transforms the abstract canvas calls to device specific calls for rendering on the specific platform. More details with regard to communication between the components is provided with regard to FIG. 8 and related discussion.

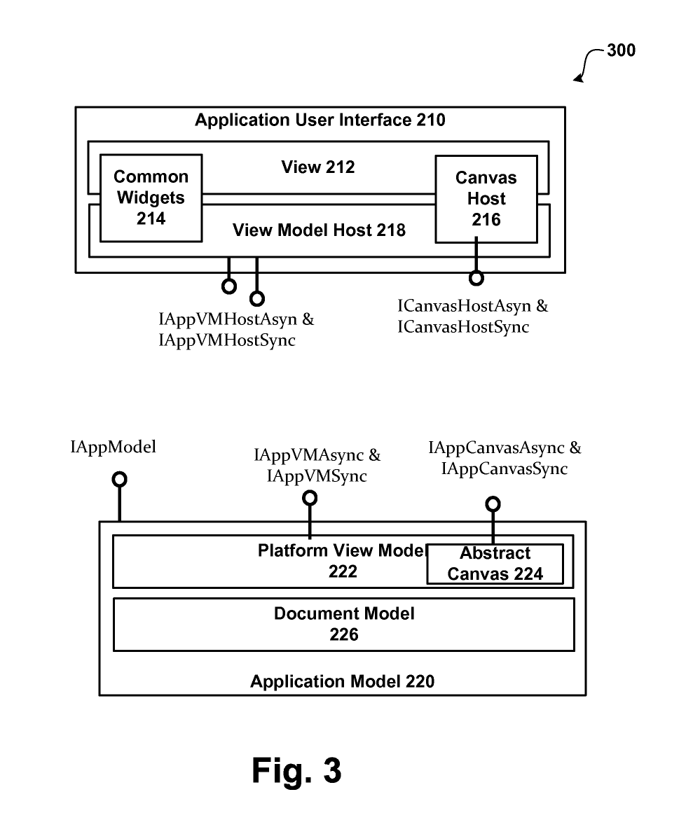

FIG. 3 shows exemplary interfaces for sharing code across platforms.

As illustrated, interfaces 300 comprises an IAppModel interface, IAppVMAsync and IAppVMSync interfaces, and IAppCanvasHostAsync and IAppCanvasHostSync interfaces. The interfaces define the asynchronous/synchronous communication between the different components (Also See FIG. 8 and related discussion).

The IAppModel interface creates and manages ViewModels and the Abstract Canvas and handles events. The IAppVMAsync, IAppVMSync, IAppCanvasHostAsync and IAppCanvasHostSync interfaces use asynchronous communication for commanding and synchronous communication for rendering target and text input.

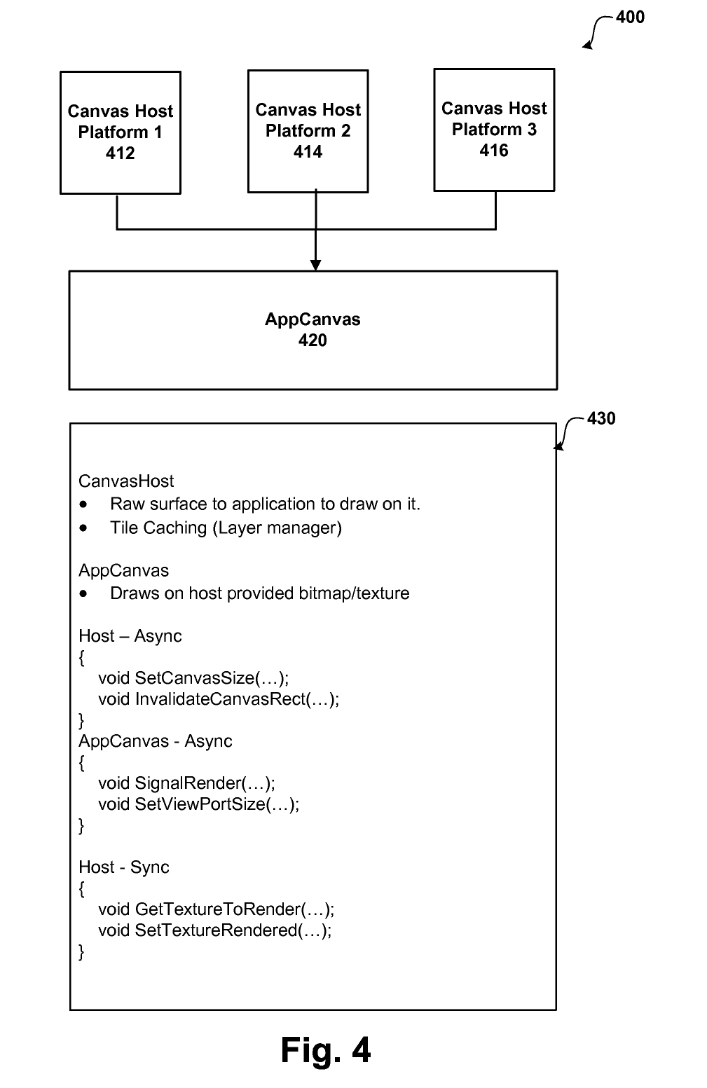

FIG. 4 shows exemplary interfaces for to an application canvas.

As illustrated, system 400 includes canvas host 1 (412), canvas host 2 (414), canvas host 3 (416), application canvas 420 and interfaces 430. While three different platforms are illustrated, there may be more/less platforms that utilize an abstract application canvas. Each platform typically uses different interfaces for rendering. For example, one platform may use GLSurfaceView and OpenGL (e.g. GOOGLE platform), another platform may use UIScrollView and Open GL (e.g. APPLE platform), another platform may use Zoomer and TiledSurfaceHost and D3D (e.g. MICROSOFT platform), and the like.

The canvas host for each platform is the raw surface an application draws on that is device specific. The application canvas 420 draws on the host the provided bitmap/texture. Platform specific code is used to implement the drawing instructed using the platform neutral APIs specified in the application model.

Exemplary platform neutral APIs (430) for rendering include: SetCanvasSize, InvalidateCanvasRect, SignalRender, SetViewPortSize, GetTextureToRender and SetTextureRendered.

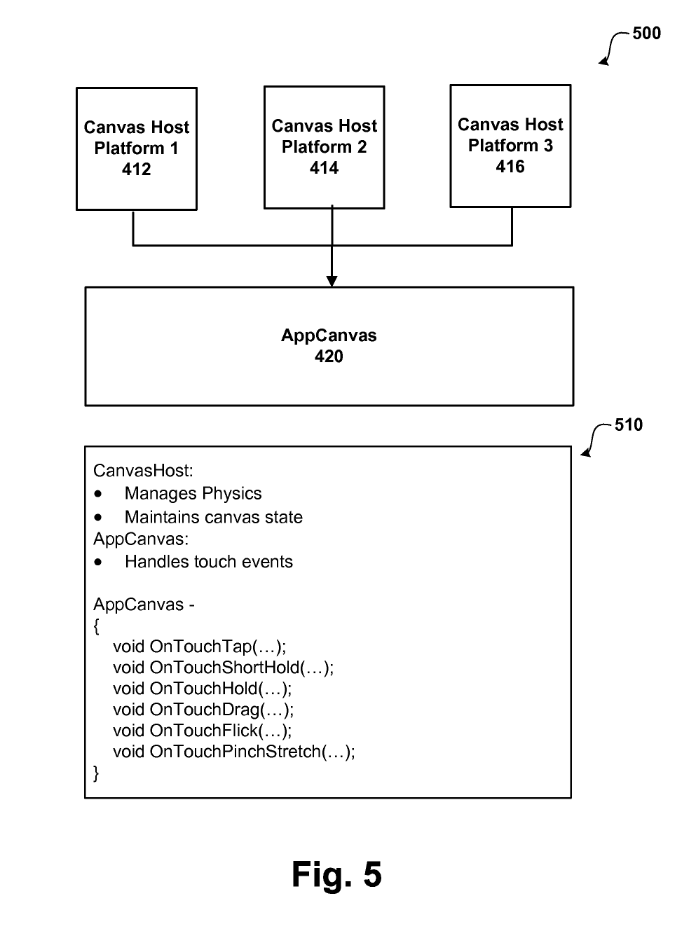

FIG. 5 shows exemplary touch interfaces.

As illustrated, system 500 includes canvas host 1 (412), canvas host 2 (414), canvas host 3 (416), application canvas 420 and interfaces 510.

Each platform uses different interfaces for touch input. For example, one platform may use OnGestureListener::OnScroll (e.g. GOOGLE platform), another platform may use UIPanGestureRecognizer (e.g. APPLE platform), another platform may use IUIXInputHandler:OnTouchDrag (e.g. MICROSOFT platform), and the like. Platform specific code is used to implement the touch input using the platform neutral APIs specified by the application model.

Exemplary APIs (510) for touch input include: an OnTouchTap interface that is used when a tap is detected, an OnTouchShortHold interface that is used when a short hold is detected, an OnTouchHold interface that is used when a hold is detected, an OnTouchDrag interface that is used when a drag is detected, an OnTouchFlick interface that is used when a flick is detected and an OnTouchPinchStretch interface that is used when a pinch or stretch gesture is detected that is platform neutral.

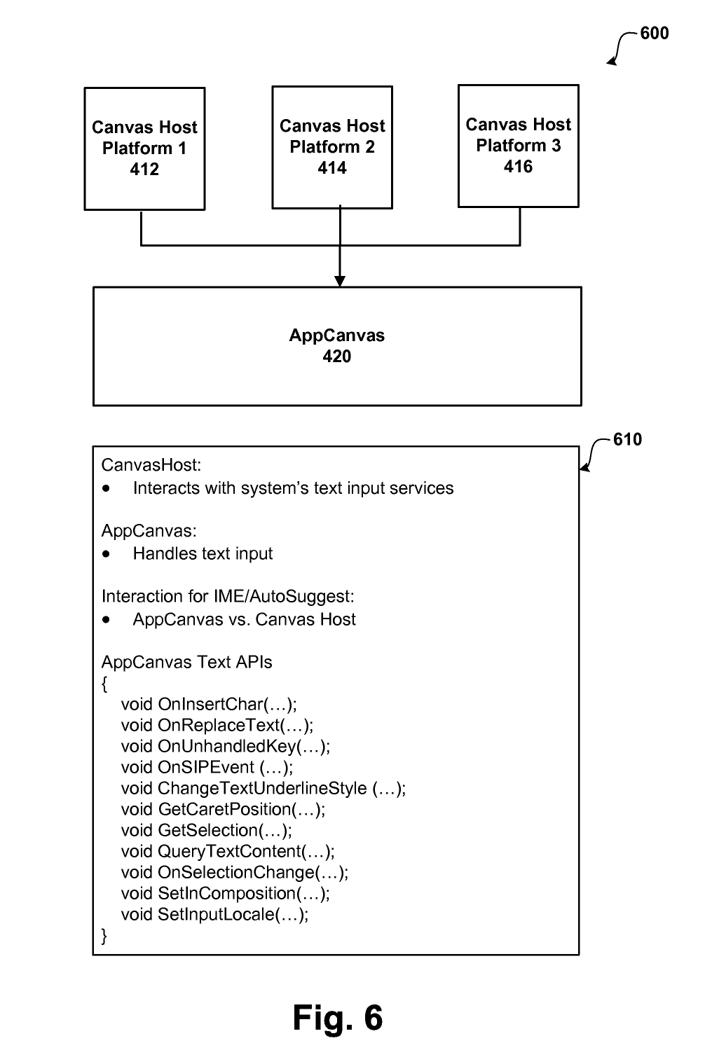

FIG. 6 shows exemplary text interfaces.

As illustrated, system 600 includes canvas host 1 (412), canvas host 2 (414), canvas host 3 (416), application canvas 420 and interfaces 610.

Each platform uses different interfaces for text input. For example, one platform may use InputConnection::commitText (e.g. GOOGLE platform), another platform may use UITextInput::replaceRange:withText (e.g. APPLE platform), another platform may use ITextInputClientOwner::ReplaceText (e.g. MICROSOFT platform), and the like. Platform specific code is used to implement the text input using the platform neutral APIs specified by the application model.

Exemplary APIs (610) for text input include: OnInsertChar for inserting a character, OnReplaceText for replacing text, OnUnhandledKey for unhandled keys, OnSIPEvent for events relating to a software input panel, ChangeTextUnderlineStyle to change styles, GetCaretPosition to determine a location of a caret, QueryTextContent to determine textual content, OnSelectionChange, SetInComposition to set composition and SetInputLocaleGetSelection for setting/getting of user preference information related to the user's language, environment and/or cultural conventions.

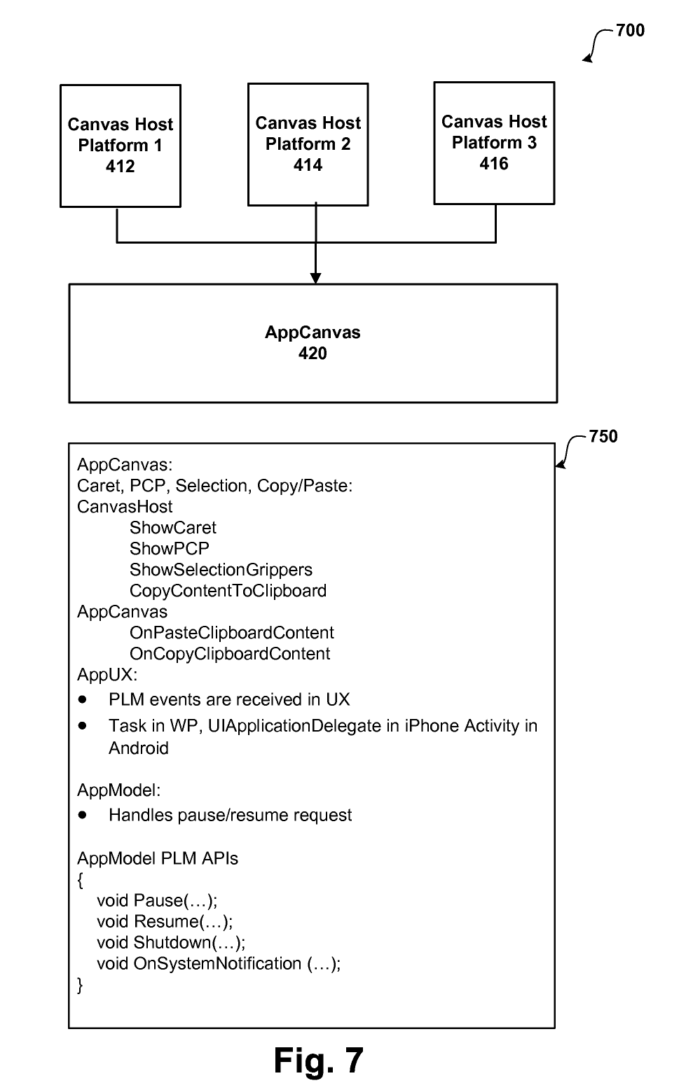

FIG. 7 shows exemplary caret and copy/paste interfaces.

As illustrated, system 700 includes canvas host 1 (412), canvas host 2 (414), canvas host 3 (416), application canvas 420 and interfaces 750.

Each platform uses different interfaces. Platform specific code is used to implement the text input using the platform neutral APIs specified by the application model

Exemplary APIs 710 include: ShowCaret; ShowPCP; ShowSelectionGrippers; CopyContentToClipboard; OnPasteClipboardContent and OnCopyClipboardContent.

APIs 710 also show different PLM events including for pausing, resuming, shutdown, and receiving system notifications. In this way, the common code within the application model can handle events such as switching between applications, handling system notifications, and the like.

FIG. 8 shows asynchronous communication and threading between an application model and different platforms.

As illustrated, system 800 includes three different platforms including platform 1 (802), platform 2 (820) and platform 3 (830); application model asynchronous task queue 840 and application model 850. Each platform includes an application user interface (804, 824, 834) and an application asynchronous task queue (806, 826 and 836).

Communication between the application user interface and the application model occurs similarly to a client-server model. A boundary exists between the application user interface for the platform and the application model. The calls from the application user interface to the application model are serialized using an asynchronous task queue. In this way, the application model 850 is isolated from the specific threading model implemented by each of the different platforms. The code in the application model is executed by application model threads and worker threads. As such, other threads are free to process user events such that responsiveness of the application is maintained.

A majority of the calls from the application model to the application UX are made using asynchronous calls. Some calls (e.g. rendering surface acquisition and copying data may be synchronous calls (including locking).

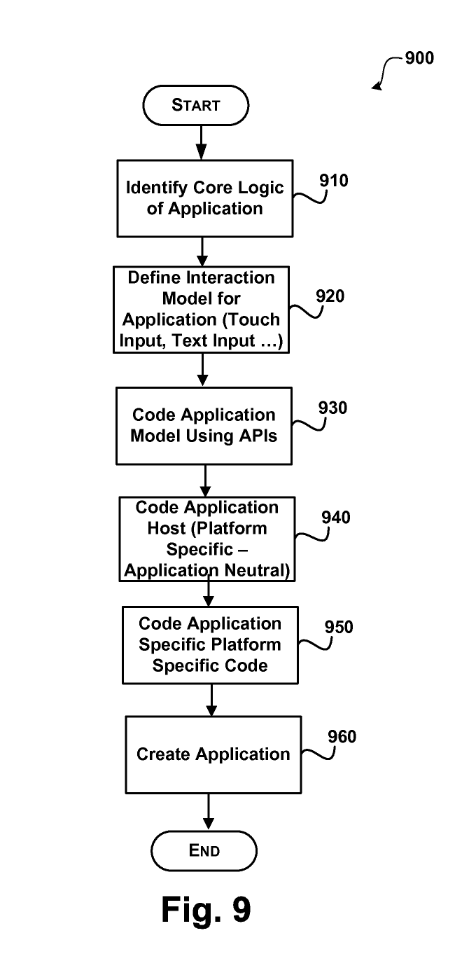

FIG. 9 shows an illustrative process for sharing code across different platforms. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, process 900 flows to operation 910, where the core logic of the application is identified. The core logic defines the main functionality of the application including what to draw as well as how to interact with the content of the application. The core logic is platform neutral and is usable across different platforms and is included within the application model. Generally, what to draw and the desired input handling behavior accounts for a vast majority of the code for an application (e.g. 5000K for the platform neutral code as compared to 50K for platform specific code).

Moving to operation 920, the interaction model for handling the user input for the application is defined. For example, how to interact with content (e.g. touch input, text input, selection . . . ). According to an embodiment, the interaction models are part of the application model and the code used between different platforms is consistent.

Flowing to operation 930, the application model is coded using the platform neutral APIs. Platform neutral Application Programming Interfaces (APIs) abstract the functionality of the application such that the platform neutral code is portable across different platforms. According to an embodiment, the APIs include functionality for rendering, text input, touch input, selection of content, copying/pasting, system events, and the like.

Transitioning to operation 940, the application host is coded. The application host includes platform specific code that is application neutral.

Moving to operation 950, the platform specific functionality is coded (if not already completed for another application).

Flowing to operation 960, the application is created for the specific type of platform using the platform neutral components and device specific components.

The process then flows to an end operation and returns to processing other actions.

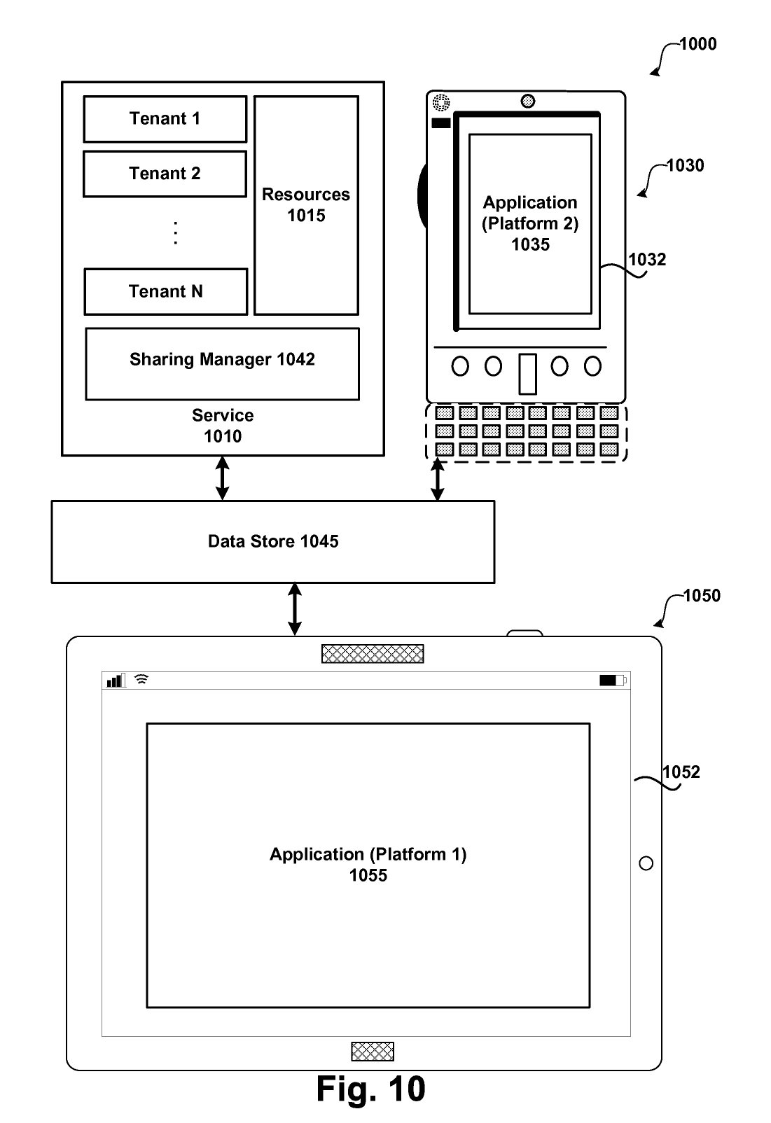

FIG. 10 illustrates an exemplary system for sharing code across different platforms. As illustrated, system 1000 includes service 1010, data store 1045, touch screen input device/display 1050 (e.g. a slate) and smart phone 1030.

As illustrated, service 1010 is a cloud based and/or enterprise based service that may be configured to provide services, such as productivity services (e.g. MICROSOFT OFFICE 365 or some other cloud based/online service that is used to interact with items (e.g. messages, spreadsheets, documents, charts, and the like). The service may be interacted with using different types of input/output. For example, a user may use touch input, hardware based input, speech input, and the like. The service may provide speech output that combines pre-recorded speech and synthesized speech. Functionality of one or more of the services/applications provided by service 1010 may also be configured as a client/server based application. For example, a client device may include an application that is created using platform neutral components and application specific components. Although system 1000 shows a service relating to productivity applications, other services/applications may be configured.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device/display 1050 (e.g. a slate/tablet device) and smart phone 1030 that detects when a touch input has been received (e.g. a finger touching or nearly touching the touch screen). The platforms may be the same type of platform and/or different types of platforms. Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030 and touch screen input device/display 1050 are configured with an application (e.g. applications 1035 and 1055) ported to each of the platforms. Smart phone 1030 and touch screen input device/display 1050 may also be configured to include different applications.

As illustrated, touch screen input device/display 1050 and smart phone 1030 shows exemplary displays 1052/1032 showing the use of an application (1035, 1055). Data may be stored on a device (e.g. smart phone 1030, slate 1050 and/or at some other location (e.g. network data store 1045). The applications 1035, 1055 may be a client based application, a server based application, a cloud based application and/or some combination.

Sharing manager 1042 is configured to perform operations relating to sharing code across applications for different platforms. While manager 1042 is shown within service 1010, the functionality of the manager may be included in other locations (e.g. on smart phone 1030 and/or slate device 1050). Sharing manager 1042 may be configured to provide platform neutral APIs for creating common code for an application as described herein.

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

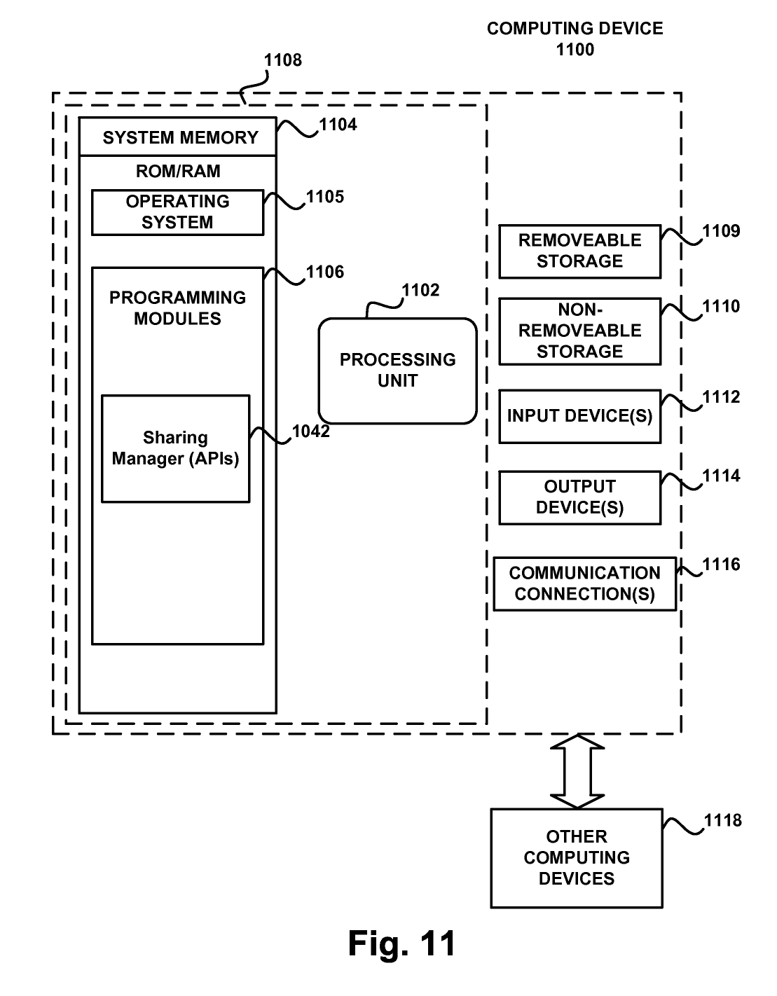

FIGS. 11-13 and the associated descriptions provide a discussion of a variety of operating environments in which embodiments of the invention may be practiced. However, the devices and systems illustrated and discussed with respect to FIGS. 11-13 are for purposes of example and illustration and are not limiting of a vast number of computing device configurations that may be utilized for practicing embodiments of the invention, described herein.

FIG. 11 is a block diagram illustrating example physical components of a computing device 1100 with which embodiments of the invention may be practiced. The computing device components described below may be suitable for the computing devices described above. In a basic configuration, computing device 1100 may include at least one processing unit 1102 and a system memory 1104. Depending on the configuration and type of computing device, system memory 1104 may comprise, but is not limited to, volatile (e.g. random access memory (RAM)), non-volatile (e.g. read-only memory (ROM)), flash memory, or any combination. System memory 1104 may include operating system 1105, one or more programming modules 1106, and may include a web browser application 1120. Operating system 1105, for example, may be suitable for controlling computing device 1100's operation. In one embodiment, programming modules 1106 may include a sharing manager 1042, as described above , installed on computing device 1100. Furthermore, embodiments of the invention may be practiced in conjunction with a graphics library, other operating systems, or any other application program and is not limited to any particular application or system. This basic configuration is illustrated in FIG. 11 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated by a removable storage 1109 and a non-removable storage 1110.

As stated above, a number of program modules and data files may be stored in system memory 1104, including operating system 1105. While executing on processing unit 1102, programming modules 1106, such as the manager may perform processes including, for example, operations related to method 900 as described above. The aforementioned process is an example, and processing unit 1102 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 1042 may be operated via application-specific logic integrated with other components of the computing device/system 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, etc. Output device(s) 1114 such as a display, speakers, a printer, etc. may also be included. The aforementioned devices are examples and others may be used.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

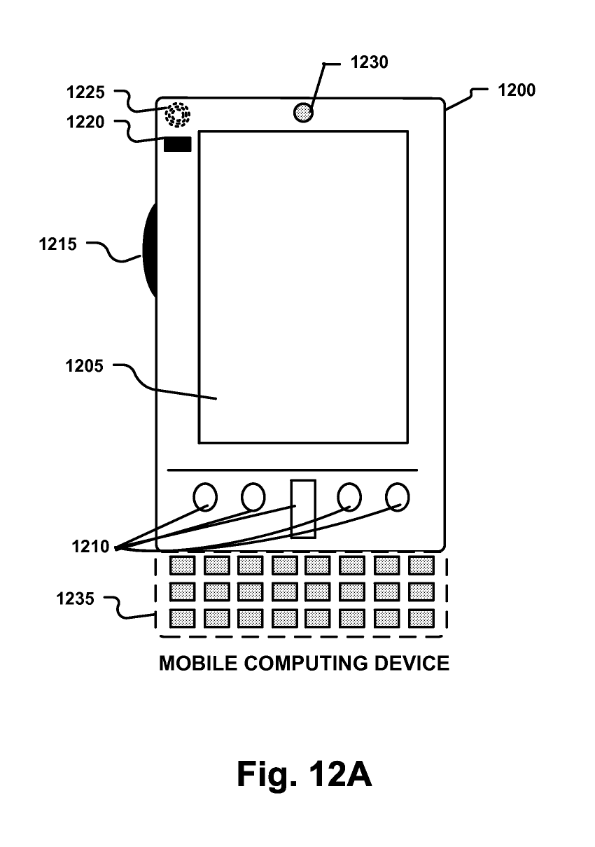

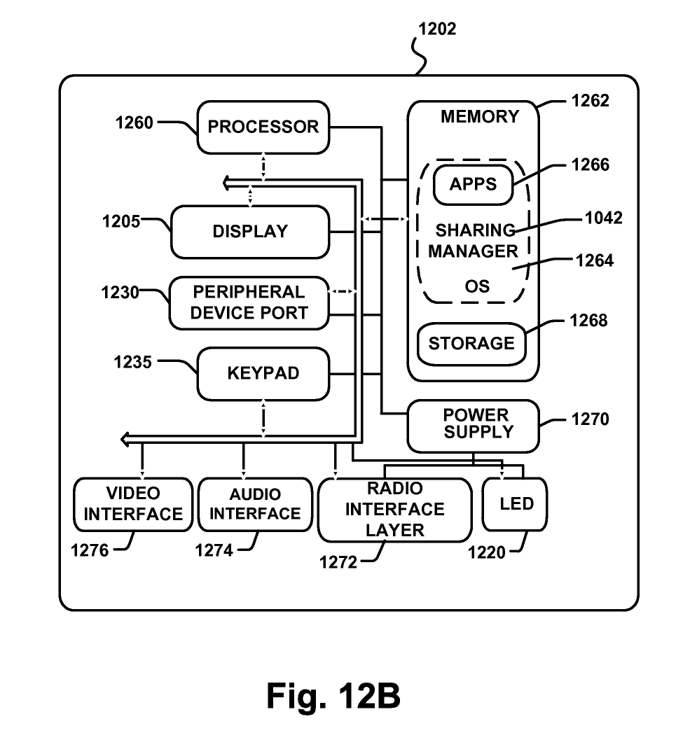

FIGS. 12A and 12B illustrate a suitable mobile computing environment, for example, a mobile telephone, a smartphone, a tablet personal computer, a laptop computer, and the like, with which embodiments of the invention may be practiced. With reference to FIG. 12A, an example mobile computing device 1200 for implementing the embodiments is illustrated. In a basic configuration, mobile computing device 1200 is a handheld computer having both input elements and output elements. Input elements may include touch screen display 1205 and input buttons 1215 that allow the user to enter information into mobile computing device 1200. Mobile computing device 1200 may also incorporate an optional side input element 1215 allowing further user input. Optional side input element 1215 may be a rotary switch, a button, or any other type of manual input element. In alternative embodiments, mobile computing device 1200 may incorporate more or less input elements. For example, display 1205 may not be a touch screen in some embodiments. In yet another alternative embodiment, the mobile computing device is a portable phone system, such as a cellular phone having display 1205 and input buttons 1215. Mobile computing device 1200 may also include an optional keypad 1235. Optional keypad 1215 may be a physical keypad or a “soft” keypad generated on the touch screen display.

Mobile computing device 800 incorporates output elements, such as display 1205, which can display a graphical user interface (GUI). Other output elements include speaker 1225 and LED light 1220. Additionally, mobile computing device 1200 may incorporate a vibration module (not shown), which causes mobile computing device 1200 to vibrate to notify the user of an event. In yet another embodiment, mobile computing device 1200 may incorporate a headphone jack (not shown) for providing another means of providing output signals.

Although described herein in combination with mobile computing device 1200, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 12B is a block diagram illustrating components of a mobile computing device used in one embodiment, such as the computing device shown in FIG. 12A. That is, mobile computing device 1200 can incorporate system 1202 to implement some embodiments. For example, system 1202 can be used in implementing a “smart phone” that can run one or more applications similar to those of a desktop or notebook computer such as, for example, browser, e-mail, scheduling, instant messaging, and media player applications. In some embodiments, system 1202 is integrated as a computing device, such as an integrated personal digital assistant (PDA) and wireless phoneme.

One or more application programs 1266 may be loaded into memory 862 and run on or in association with operating system 1264. Examples of application programs include phoneme dialer programs, e-mail programs, PIM (personal information management) programs, word processing programs, spreadsheet programs, Internet browser programs, messaging programs, and so forth. System 1202 also includes non-volatile storage 1268 within memory 1262. Non-volatile storage 1268 may be used to store persistent information that should not be lost if system 1202 is powered down. Applications 1266 may use and store information in non-volatile storage 1268, such as e-mail or other messages used by an e-mail application, and the like. A synchronization application (not shown) may also reside on system 1202 and is programmed to interact with a corresponding synchronization application resident on a host computer to keep the information stored in non-volatile storage 1268 synchronized with corresponding information stored at the host computer. As should be appreciated, other applications may be loaded into memory 1262 and run on the device 1200, including the sharing manager 1042, described above.

System 1202 has a power supply 1270, which may be implemented as one or more batteries. Power supply 1270 might further include an external power source, such as an AC adapter or a powered docking cradle that supplements or recharges the batteries.

System 1202 may also include a radio 1272 that performs the function of transmitting and receiving radio frequency communications. Radio 1272 facilitates wireless connectivity between system 1202 and the “outside world”, via a communications carrier or service provider. Transmissions to and from radio 1272 are conducted under control of OS 1264. In other words, communications received by radio 1272 may be disseminated to application programs 1266 via OS 1264, and vice versa.

Radio 1272 allows system 1202 to communicate with other computing devices, such as over a network. Radio 1272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 1202 is shown with two types of notification output devices; LED 1220 that can be used to provide visual notifications and an audio interface 1274 that can be used with speaker 1225 to provide audio notifications. These devices may be directly coupled to power supply 1270 so that when activated, they remain on for a duration dictated by the notification mechanism even though processor 1260 and other components might shut down for conserving battery power. LED 1220 may be programmed to remain on indefinitely until the user takes action to indicate the powered-on status of the device. Audio interface 1274 is used to provide audible signals to and receive audible signals from the user. For example, in addition to being coupled to speaker 1225, audio interface 1274 may also be coupled to a microphone 1220 to receive audible input, such as to facilitate a telephone conversation. In accordance with embodiments of the present invention, the microphone 1220 may also serve as an audio sensor to facilitate control of notifications, as will be described below. System 1202 may further include video interface 1276 that enables an operation of on-board camera 1230 to record still images, video stream, and the like.

A mobile computing device implementing system 1202 may have additional features or functionality. For example, the device may also include additional data storage devices (removable and/or non-removable) such as, magnetic disks, optical disks, or tape. Such additional storage is illustrated in FIG. 12B by storage 1268. Computer storage media may include volatile and nonvolatile, removable and non-removable media implemented in any method or technology for storage of information, such as computer readable instructions, data structures, program modules, or other data.

Data/information generated or captured by the device 1200 and stored via the system 1202 may be stored locally on the device 1200, as described above, or the data may be stored on any number of storage media that may be accessed by the device via the radio 1272 or via a wired connection between the device 1200 and a separate computing device associated with the device 1200, for example, a server computer in a distributed computing network such as the Internet. As should be appreciated such data/information may be accessed via the device 1200 via the radio 1272 or via a distributed computing network. Similarly, such data/information may be readily transferred between computing devices for storage and use according to well-known data/information transfer and storage means, including electronic mail and collaborative data/information sharing systems.

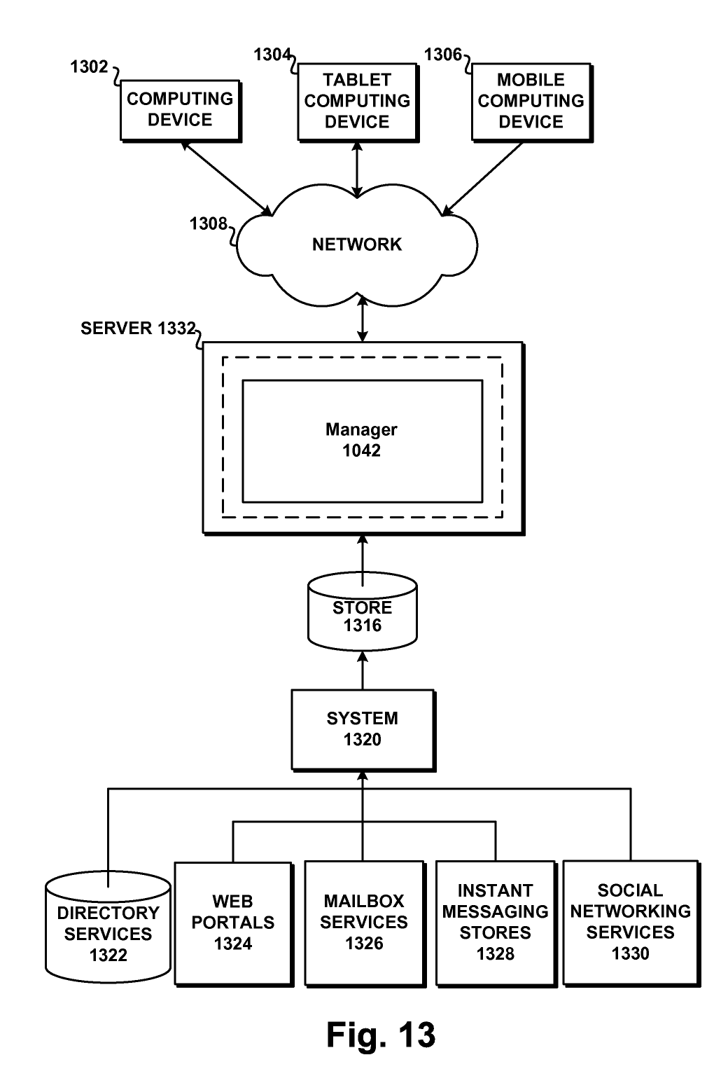

FIG. 13 illustrates a system architecture for an application using shared code across different types of devices.

Components managed via the sharing manager 1342 may be stored in different communication channels or other storage types. For example, components along with information from which they are developed may be stored using directory services 1322, web portals 1324, mailbox services 1326, instant messaging stores 1328 and social networking sites 1330. The systems/applications 1042, 1320 may use any of these types of systems or the like for enabling management and storage of components in a store 1316. A server 1332 may provide communications and services relating to creating an application using shared code across different platforms. Server 1332 may provide services and content over the web to clients through a network 1308. Examples of clients that may utilize server 1332 include computing device 1302, which may include any general purpose personal computer, a tablet computing device 1304 and/or mobile computing device 1306 which may include smart phones. Any of these devices may obtain display component management communications and content from the store 1316.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for sharing application code for an application across different platforms, comprising:
defining an application model including platform neutral code for an application that includes an interaction model defining user interactions for the application and defines what to draw for the application;
providing platform neutral Application Programming Interfaces (APIs) for abstracting the interaction and drawing for the application that are used by the code in the application model; and
creating the application using the code developed for the application model using the APIs.

2. The method of claim 1, wherein defining the application model comprises utilizing an abstract application canvas used for drawing content related to the application that is platform neutral.

3. The method of claim 1, wherein defining the interaction model comprises utilizing an abstract application canvas used for receiving user input related to the application that is platform neutral.

4. The method of claim 1, wherein the APIs define functionality related to touch input comprising methods for: an OnTouchTap interface that is used when a tap is detected, an OnTouchShortHold interface that is used when a short hold is detected, an OnTouchHold interface that is used when a hold is detected, an OnTouchDrag interface that is used when a drag is detected, an OnTouchFlick interface that is used when a flick is detected and an OnTouchPinchStretch interface that is used when a pinch or stretch gesture is detected that is platform neutral.

5. The method of claim 1, wherein the APIs define functionality related to text input comprising methods for: an OnInsertChar interface; an OnReplaceText interface; an OnUnhandledKey interface; an OnSIPEvent interface; a ChangeTextUnderlineStyle interface; an GetCaretPosition interface; a GetSelection interface; a QueryTextContent interface; and an OnSelectionChange interface that is platform neutral.

6. The method of claim 1, wherein the APIs define functionality related to rendering APIs comprising methods for: a SetCanvasSize interface, a GetTextureToRender interface, a SetTextureRendered interface, and an InvalidateCanvasRect interface that is platform neutral.

7. The method of claim 1, wherein the APIs define functionality related to rendering comprising methods for: a ShowCaret interface, a ShowPCP interface, and a ShowSelectionGrippers interface that is platform neutral.

8. The method of claim 1, wherein the APIs define functionality related APIs comprising methods for an OnPasteClipboardContent interface and an OnCopyClipboardContent that is platform neutral.

9. The method of claim 1, further comprising defining a communication model between platform neutral components and platform specific components including an asynchronous communication that stores tasks in an asynchronous task queue.

10. A computer-readable medium having computer-executable instructions for sharing application code for an application across different platforms, comprising:
providing platform neutral Application Programming Interfaces (APIs) for abstracting interaction and drawing for an application that are used by the code in an application model that is shared across platforms and comprise touch methods, text methods, and rendering methods;
defining an application model including platform neutral code using methods from the APIs for an application that includes an interaction model defining user interactions for the application and defines what to draw for the application; and
creating the application across different platforms using the code developed for the application model using the APIs.

11. The computer-readable medium of claim 10, wherein the APIs define functionality related to touch input comprising methods for: an OnTouchTap interface that is used when a tap is detected, an OnTouchShortHold interface that is used when a short hold is detected, an OnTouchHold interface that is used when a hold is detected, an OnTouchDrag interface that is used when a drag is detected, an OnTouchFlick interface that is used when a flick is detected and an OnTouchPinchStretch interface that is used when a pinch or stretch gesture is detected that is platform neutral.

12. The computer-readable medium of claim 10, wherein the APIs define functionality related to text input comprising methods for: an OnInsertChar interface; an OnReplaceText interface; an OnSIPEvent interface; a ChangeTextUnderlineStyle interface; a GetCaretPosition interface; a GetSelection interface; a QueryTextContent interface; and an OnSelectionChange interface that is platform neutral.

13. The computer-readable medium of claim 10, wherein the APIs define functionality related to rendering APIs comprising methods for: a SetCanvasSize interface, a GetTextureToRender interface, s SetTextureRendered interface, and an InvalidateCanvasRect interface that is platform neutral.

14. The computer-readable medium of claim 10, wherein the APIs define functionality related to rendering comprising methods for: a ShowCaret interface, a ShowPCP interface, and a ShowSelectionGrippers interface that is platform neutral.

15. The computer-readable medium of claim 10, wherein the APIs define functionality related APIs comprising methods for an OnPasteClipboardContent interface and an OnCopyClipboardContent that is platform neutral.

16. The computer-readable medium of claim 10, wherein the APIs define functionality related APIs comprising methods for interacting with system events including pausing, resuming, shutdown and system notifications.

17. A system for sharing application code for an application across different platforms, comprising:
a processor and a computer-readable medium;
an operating environment stored on the computer-readable medium and executing on the processor; and
a sharing manager operating under the control of the operating environment and operative to actions comprising:
providing platform neutral Application Programming Interfaces (APIs) for abstracting interaction and drawing for an application that are used by the code in an application model that is shared across platforms and comprise touch methods, text methods, and rendering methods;
defining an application model including platform neutral code using methods from the APIs for an application that includes an interaction model defining user interactions for the application and defines what to draw for the application; and
creating the application across different platforms using the code developed for the application model using the APIs.

18. The system of claim 17, wherein the APIs define functionality related to touch input comprising methods for: an OnTouchTap interface that is used when a tap is detected, an OnTouchShortHold interface that is used when a short hold is detected, an OnTouchHold interface that is used when a hold is detected, an OnTouchDrag interface that is used when a drag is detected, an OnTouchFlick interface that is used when a flick is detected and an OnTouchPinchStretch interface that is used when a pinch or stretch gesture is detected that is platform neutral.

19. The system of claim 17, wherein the APIs define functionality related to text input and rendering comprising methods for: an OnInsertChar interface; an OnReplaceText interface; an OnUnhandledKey interface; an OnSIPEvent interface; a ChangeTextUnderlineStyle interface; an GetCaretPosition interface; a GetSelection interface; a QueryTextContent interface; and an OnSelectionChange interface, a SetCanvasSize interface, a GetTextureToRender interface, Sa etTextureRendered interface, and an InvalidateCanvasRect interface that are platform neutral.

20. The system of claim 17, further comprising defining a communication model between platform neutral components and platform specific components including an asynchronous communication that stores tasks in an asynchronous task queue
